(19) United States
(12) Patent Application Publication
(10) Pub. No.: US 2009/0073960 A1
(43) Pub. Date: Mar. 19, 2009

(54) BRIDGING PHONE NETWORKS USING VOIP TO PRESERVE IN-NETWORK CALLING ADVANTAGES

(75) Inventor: Chris T. Kalaboukis, Los Gatos, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/856,912

(22) Filed: Sep. 18, 2007

(51) Int. Cl. H04L 12/66

(52) U.S. Cl. 370/352

(57) ABSTRACT

A call may be accomplished from a first mobile network to a second mobile network by bridging the first and second mobile networks using VoIP. A first communication is initiated from a first mobile device to a first Voice over Internet Protocol (VoIP) server circuitry emulating a mobile phone. The first VoIP server circuitry receives an indication of a destination number of a mobile phone on the second mobile network. Communication takes place between the first VoIP server circuitry and the second VoIP server circuitry according to an internet protocol to conference the first mobile device on a first telephone call, to the first VoIP server, to the second mobile device, on a second telephone call to the second VoIP server. The first and second telephone call are each intra-network, and the VoIP communication accomplishes a bridge between the first mobile network and the second mobile network. The second telephone call may be via a plain old telephone service (POTS) rather than via a second mobile network.

### BACKGROUND

The present invention relates to mobile phones and mobile phone calling plans. In particular, the present invention relates to the use of Voice over Internet Protocol (VoIP) to more fully utilize “included minutes” features in mobile phone calling plans.

Mobile phone carrier calling plans are well known. Features of such calling plans include, for example, long-distance calling features whereby minutes used for outgoing calls to other phone numbers associated with a particular region (such as, for example, the United States) are charged against the “included minutes” for the plan. Other features of such calling plans may include, for example, unlimited or a large number of bonus minutes to use for outgoing calls to other phone numbers within a particular network, where the phone numbers within a network typically include all subscribers to the same mobile phone carrier. Therefore, calls to numbers outside the network are charged to the “included minutes” of the calling plan, which are more limited than the bonus minutes included with the plan for in-network calling.

### SUMMARY

In accordance with an aspect, a call may be accomplished from a first mobile network to a second mobile network by bridging the first mobile network to the second mobile network using VoIP. For example, a first communication may be initiated, on the first mobile network, from a first mobile device to a first Voice over Internet Protocol (VoIP) server circuitry emulating a mobile phone, including initiating the first communication to a telephone number associated with the first VoIP server circuitry. This may include, for example, initiating a telephone call or a text message. After the first communication has been initiated, the first VoIP server circuitry receives, from the first mobile device, an indication of a destination number of a mobile phone on the second mobile network.

A first telephone call is conducted, on the first mobile network, from the first mobile device to the first Voice over Internet Protocol (VoIP) server circuitry. A second telephone call is conducted, on the second mobile network, from a second VoIP server circuitry emulating a mobile phone to the destination number of the mobile phone on the second mobile network. Communication takes place between the first VoIP server circuitry and the second VoIP server circuitry according to an internet protocol to conference the first mobile device on the first telephone call to the second mobile device on the second telephone call.

The first telephone call and the second telephone call are each intra-network, and the VoIP communication accomplishes a bridge between the first mobile network and the second mobile network.

In a similar manner, the second telephone call may be via a plain old telephone service (POTS) rather than via a second mobile network. In this way, for example, a call may be accomplished from the first mobile device to a land line telephone that is outside the first mobile network or otherwise outside included calling features of an account of the first mobile device. For example, the land line telephone may be located outside the “included” long distance minutes of the calling plan for the first mobile device, such as being located in a different country. As another example, the call to the land line telephone may be accomplished using “in network” minutes, even though the land line telephone is not within the first mobile network.

### BRIEF DESCRIPTION OF THE DRAWINGS

FIG. 1 schematically illustrates a simplified architecture of a system in which “call bridging” may be accomplished.

FIG. 2 is a flowchart illustrating an example by which a first mobile device, on a first mobile network, has a call bridged to a second mobile device, on a second mobile network.

FIG. 3 is a flowchart illustrating an example by which a first mobile device, on a first mobile network, has a call bridged to a landline telephone on a POTS network

FIG. 4 is a diagram illustrating how a VoIP server, including cellular phone emulation capability, may be configured.

FIG. 5 is a flowchart illustrating an example of processing within the input server 118 of the FIG. 1 system.

FIG. 6 is a simplified diagram of a network environment in which specific embodiments of the present invention may be implemented.

### DETAILED DESCRIPTION

In accordance with an aspect, a method is provided to accomplish a call from a first mobile network to a second mobile network by bridging the first mobile network to the second mobile network using VoIP. For example, a first communication may be initiated, on the first mobile network, from a first mobile device to a first Voice over Internet Protocol (VoIP) server circuitry emulating a mobile phone, including initiating the first communication to a telephone number associated with the first VoIP server circuitry. This may include, for example, initiating a telephone call or a text message. After the first communication has been initiated, the first VoIP server circuitry receives, from the first mobile device, an indication of a destination number of a mobile phone on the second mobile network.

A first telephone call is conducted, on the first mobile network, from the first mobile device to the first Voice over Internet Protocol (VoIP) server circuitry. A second telephone call is conducted, on the second mobile network, from a second VoIP server circuitry emulating a mobile phone to the destination number of the mobile phone on the second mobile network. Communication takes place between the first VoIP server circuitry and the second VoIP server circuitry according to an internet protocol to conference the first mobile device on the first telephone call to the second mobile device on the second telephone call.

The first telephone call and the second telephone call are each intra-network, and the VoIP communication accomplishes a bridge between the first mobile network and the second mobile network.

In a similar manner, the second telephone call may be via a plain old telephone service (POTS) rather than via a second mobile network. In this way, for example, a call may be accomplished from the first mobile device to a land line telephone that is outside the first mobile network or otherwise outside included calling features of an account of the first mobile device. For example, the land line telephone may be located outside the “included” long distance minutes of the calling plan for the first mobile device, such as being located in a different country, such that calling the land line telephone directly from the first mobile device would result in charging against credits for “included” minutes, associated with the first mobile device. As another example, the call to the land line telephone may be accomplished using “in network” minutes (i.e., with charging against credits for “included minutes”), even though the land line telephone is not within the first mobile network.

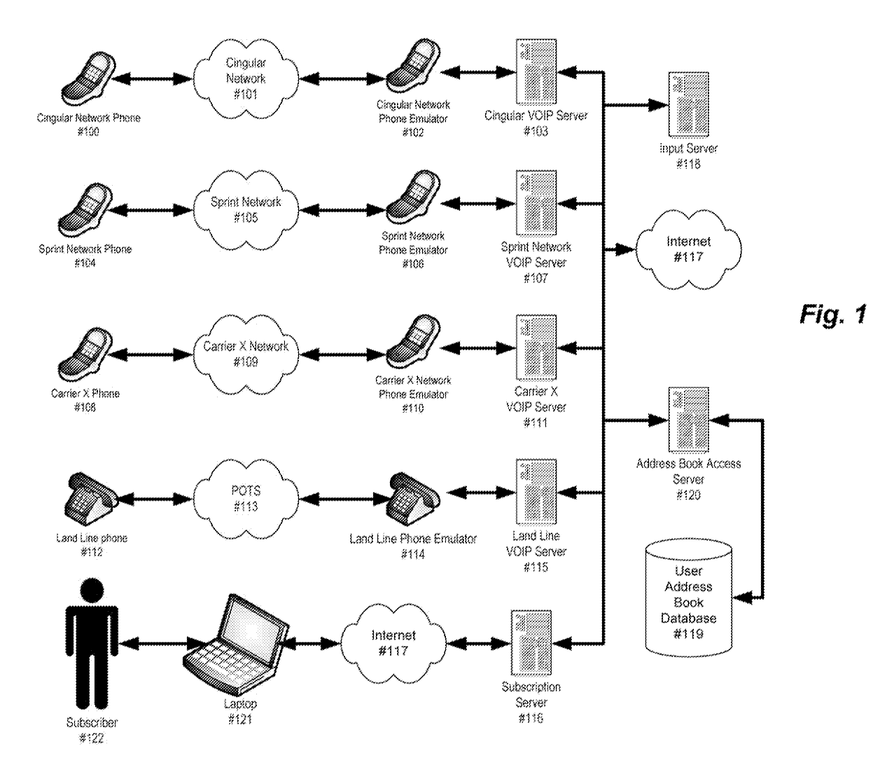

FIG. 1 schematically illustrates a simplified architecture of a system in which “call bridging,” as mentioned above, may be accomplished. Referring now to FIG. 1, phones 100, 104 and 108 may be registered with various mobile networks. In FIG. 1, the phones 100, 104 and 108 are registered with the Cingular network 101, the Sprint network 105 and the carrier “X” network 109. In addition, a land line telephone 112 may is connected to a plain old telephone service (POTS) 113.

Further in accordance with the FIG. 1 architecture, at least one VoIP server is registered with each mobile network. More particularly, in the FIG. 1 architecture, a Cingular VoIP server 103, a Sprint VoIP server 107 and a carrier “X” VoIP server are registered with the Cingular network 101, the Sprint network 105 and the carrier “X” network 109. In addition, a land line VoIP server 115 is coupled to the POTS 113. The VoIP servers are configured for communication with each other via a wide area network such as the internet 117.

Referring still to FIG. 1, an input server 118 is configured to interoperate with the various VoIP servers to accomplish the call bridging functionality. Particular examples of such interoperation will be discussed in greater detail below. In addition, a user address book database 119 and address book access server 120 may be provided to assist in resolving call destination information.

Still referring to FIG. 1, a subscription server 116 may be provided, via which a user such as subscriber 122 may register a subscription with the call bridging service, such as using a computer 121 to access the subscription server 116 via a wide area network such as the internet 117. In some examples, the call bridging service may only be available to subscribers who register with the call bridging service.

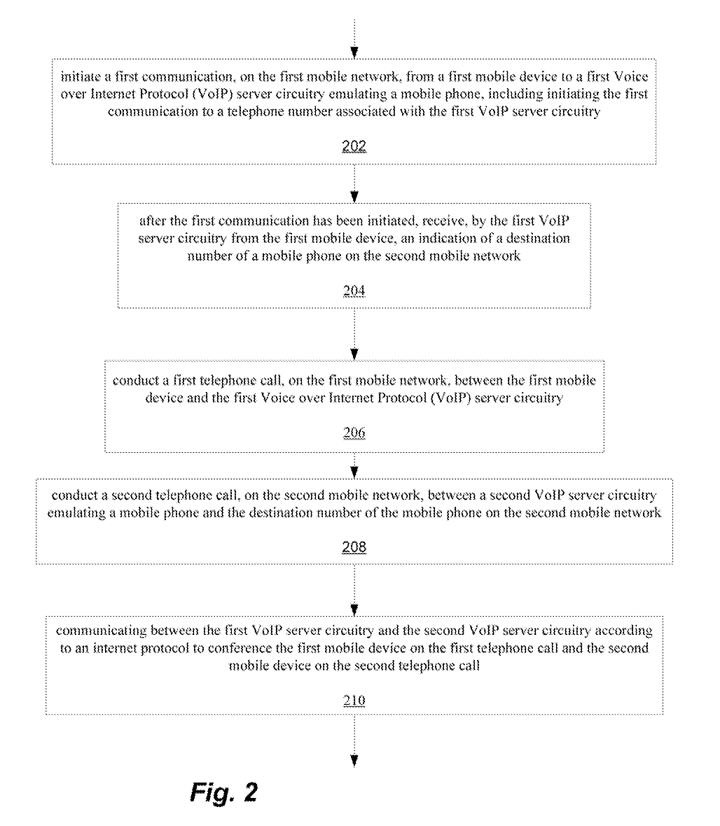

FIG. 2 is a flowchart illustrating an example by which a first mobile device, on a first mobile network, has a call bridged to a second mobile device, on a second mobile network. At 202, a first communication is initiated, on a first mobile network, from a first mobile device to a first VoIP server circuitry emulating a mobile phone. This includes, for example, initiating the first communication to a telephone number associated with the first VoIP server circuitry.

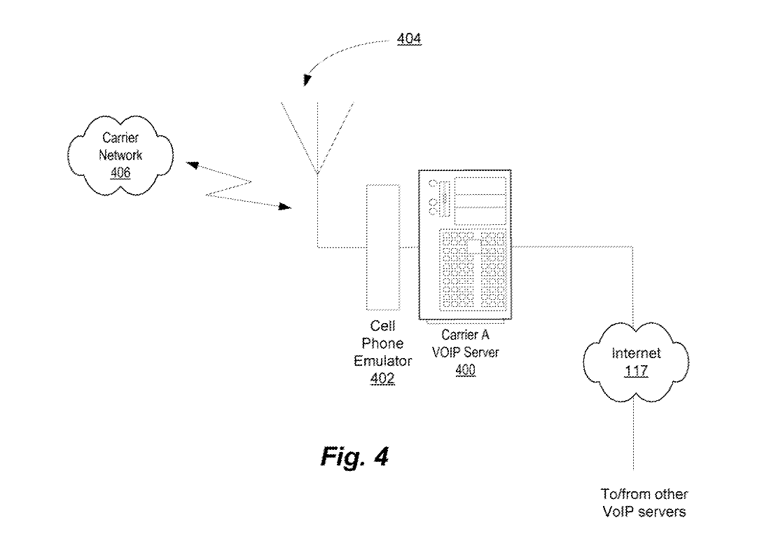

For example, at 202, and referring back to the FIG. 1 architecture, a call or text message may be initiated from a mobile phone 100, on the Cingular network 101, to the Cingular VoIP server 103 via the telephone number on the Cingular network of a Cingular network phone emulator 102. An example of a configuration of a network phone emulator configured to interoperate with a VoIP server is discussed later, with reference to FIG. 4.

At 204, after the first communication has been initiated, the first VoIP server receives, from the first mobile device, an indication of a destination number of a mobile phone on the second mobile phone network. For example, at 204, the Cingular VoIP server 103 may receive, from the mobile phone 100, an indication of the phone number of the mobile phone 104. The indication may be, for example, the number itself or, perhaps, an alias for the destination number that may be resolved such as, for example, by consulting the user address book database 119 via the address book access server 120.

At 206, a first telephone call is conducted, on the first mobile network, between the first mobile device to the first VoIP server. The first telephone call may be, for example, the first communication, that was initiated on the first mobile network to communicate, to the first VoIP server, the indication of the destination number of the mobile phone on the second mobile network. As another example, the first telephone call may be a “call back” to the first mobile phone from the first VoIP server such as, for example, once the call bridging has been set up. Referring again to the FIG. 1 architecture, the first telephone call may be conducted, on the Cingular network 101, between the mobile phone 100 and the Cingular VoIP server 103.

At 208, a second telephone call is conducted, on the second mobile network, between a second VoIP server and a second mobile phone, on the second mobile network, where the second mobile phone has the destination number received by the first VoIP server from the first mobile device, on the first mobile network. Referring to the FIG. 1 architecture, the second telephone call may be, for example, a call between the Sprint VoIP server 107 and the mobile phone 104 (i.e., the mobile phone 104 has the destination number received by the Cingular VoIP server 103).

At 210, communication between the first VoIP server and the second VoIP server according to an internet protocol conferences the first mobile device on the first telephone call (between the first mobile device and the first VoIP server) to the second mobile device on the second telephone call (between the second mobile device and the second VoIP server). Referring to the FIG. 1 architecture, the communication may be between the Cingular VoIP server 103 and the Sprint VoIP server 107.

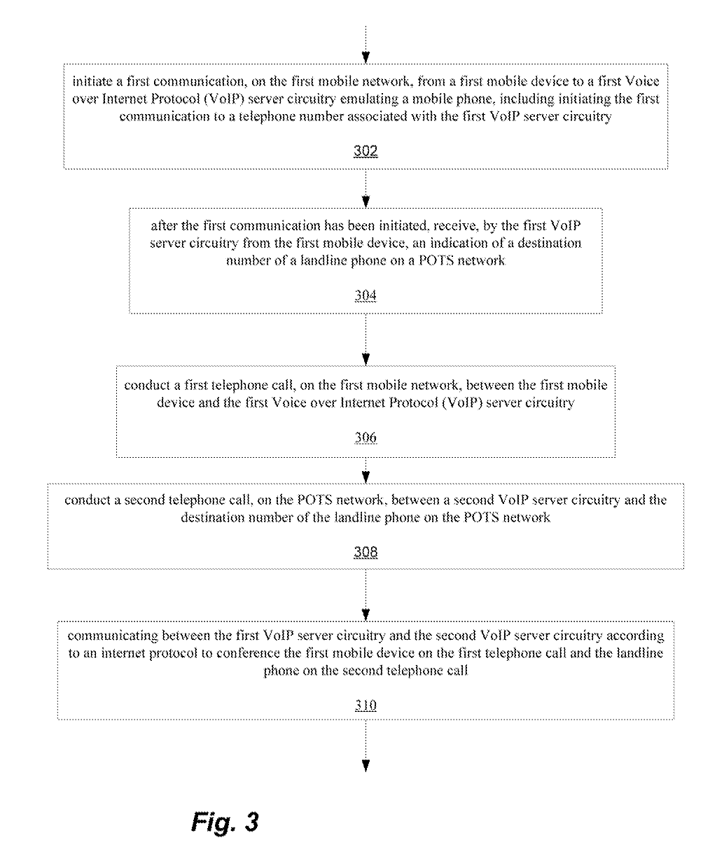

We now turn to FIG. 3, which is a flowchart illustrating an example by which a first mobile device, on a first mobile network, has a call bridged to a landline telephone on a POTS network. For example, the landline telephone number may be such that calling the landline telephone from the first mobile device would cause charges to be incurred or would use up an expendable resource of a subscription plan of the first mobile device with the first mobile network. For example, the landline telephone may be outside the area for which “free” long distance is provided (e.g., free long distance may be provided for calls within the continental United States, and the landline telephone may be located in Europe). In another example, calling the landline telephone may go against “included” minutes in the subscription, whereas in-network calling may be unlimited (either all the time or during particular periods, such as during nights and weekends, or the in-network calling may be less limited).

Turning now to FIG. 3, at 302, a first communication is initiated, on a first mobile network, from a first mobile device to a first VoIP server circuitry emulating a mobile phone. This includes, for example, initiating the first communication to a telephone number associated with the first VoIP server circuitry.

For example, at 302, and referring back to the FIG. 1 architecture, a call or text message may be initiated from a mobile phone 100, on the Cingular network 101, to the Cingular VoIP server 103 via the telephone number on the Cingular network of a Cingular network phone emulator 102.

At 304, after the first communication has been initiated, the first VoIP server receives, from the first mobile device, an indication of a destination number of a landline telephone on the POTS network. For example, at 304, the Cingular VoIP server 103 may receive, from the mobile phone 100, an indication of the phone number of the landline phone 112. The indication may be, for example, the number itself or, perhaps, an alias for the destination number that may be resolved such as, for example, by consulting the user address book database 119 via the address book access server 120.

At 306, a first telephone call is conducted, on the first mobile network, between the first mobile device to the first VoIP server. The first telephone call may be, for example, the first communication, that was initiated on the first mobile network to communicate, to the first VoIP server, the indication of the destination number of the landline phone on the POTS network. As another example, the first telephone call may be a “call back” to the first mobile phone from the first VoIP server such as, for example, once the call bridging has been set up. Referring again to the FIG. 1 architecture, the first telephone call may be conducted, on the Cingular network 101, between the mobile phone 100 and the Cingular VoIP server 103.

At 208, a second telephone call is conducted, on the landline network, between a second VoIP server and a landline phone, where the landline phone has the destination number received by the first VoIP server from the first mobile device, on the first mobile network. Referring to the FIG. 1 architecture, the second telephone call may be, for example, a call between the landline VoIP server 115 and the landline phone 112 (i.e., the landline phone 112 has the destination number received by the Cingular VoIP server 103).

At 310, communication between the first VoIP server and the second VoIP server according to an internet protocol conferences the first mobile device on the first telephone call (between the first mobile device and the first VoIP server) to the landline phone device on the second telephone call (between the landline phone and the second VoIP server). Referring to the FIG. 1 architecture, the communication may be between the Cingular VoIP server 103 and the landline VoIP server 115.

FIG. 4 is a diagram illustrating how a VoIP server, including cellular phone emulation capability, may be configured. In particular, the server may include, for example, a standard computing device 400 such as well-known computing devices that execute under a Microsoft Windows-based, Linux or other operation system. The computing device 400 is configured, by executing software, to operate as a VoIP server. The server also includes a cellular phone emulator card 402 that, for example, may operate in conjunction with driver software on the computing device 400 to emulate a cellular phone. The cellular phone emulator card 402 includes antenna circuitry 404 for transmitting to and receiving signals from a carrier network 406. In addition, the computing device 400 is further configured to interoperate over a network such as the internet 117 to other VoIP servers.

In operation of the VoIP server such as the VoIP server system illustrated in FIG. 4, when an incoming call “hits” the antenna 404 in the same way as the incoming call would be presented to any other mobile device, the call is answered under the control of the cell phone emulator circuitry 402, as well as the server 400 configured by executing software as discussed above. The information of the call is translated, in the server 400, into digital audio (such as voice) packets for transmission over the network such as the internet 117. Conversely, the VoIP server system may operate in the other direction, to translate digital audio packets received over the network for transmission out to a mobile carrier network 406.

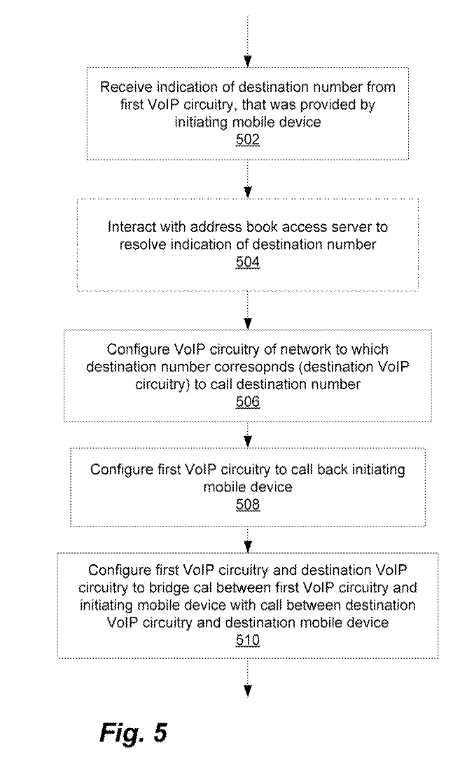

FIG. 5 is a flowchart illustrating an example of processing within the input server 118 (FIG. 1). In general, as discussed above, the input server 118 is configured to interoperate with the various VoIP servers to accomplish the call bridging functionality. At 502, the input server receives an indication of the destination number, from the first VoIP circuitry, that was provided by initiating mobile device. At 504, as appropriate, the input server Interacts with an address book access server to resolve indication of destination number. At 506, the input server configures the VoIP circuitry of network to which destination number corresponds (destination VoIP circuitry), to call the destination number. At 508, the input server configures the first VoIP circuitry to call back the initiating mobile device. At 510, the input server configures the first VoIP circuitry and destination VoIP circuitry to bridge call between first VoIP circuitry and initiating mobile device with call between destination VoIP circuitry and destination mobile device.

Throughout this description, we have described examples of methods with steps in a particular order. It should be understood that, generally, the method steps need not be carried out in any particular order unless required by the plain language.

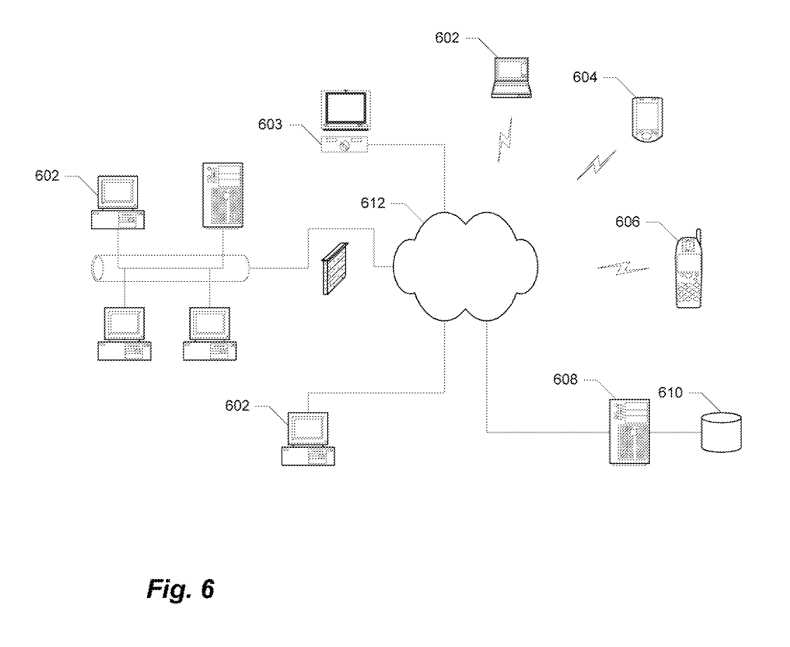

Embodiments of the present invention may be employed in any of a wide variety of computing contexts. For example, as illustrated in FIG. 6, implementations are contemplated in which users may interact with a diverse network environment via any type of computer (e.g., desktop, laptop, tablet, etc.) 602, media computing platforms 603 (e.g., cable and satellite set top boxes and digital video recorders), handheld computing devices (e.g., PDAs) 604, cell phones 606, or any other type of computing or communication platform.

According to various embodiments, applications may be executed locally, remotely or a combination of both. The remote aspect is illustrated in FIG. 6 by server 608 and data store 610 which, as will be understood, may correspond to multiple distributed devices and data stores.

The various aspects of the invention may also be practiced in a wide variety of network environments (represented by network 612) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

What is claimed is:

1. A method of accomplishing a call from a first mobile network to a second network by bridging the first mobile network to the second network, the method comprising:
initiating a first communication, on the first mobile network, from a first mobile device to a first Voice over Internet Protocol (VoIP) server circuitry emulating a mobile phone, including initiating the first communication to a telephone number associated with the first VoIP server circuitry;
after the first communication has been initiated, receiving, by the first VoIP server circuitry from the first mobile device, an indication of a destination number of a phone on the second network;
conducting a first telephone call, on the first mobile network, between the first mobile device to the first Voice over Internet Protocol (VoIP) server circuitry;
conducting a second telephone call, on the second network, between a second VoIP server circuitry and the destination number of the phone on the second network; and
communicating between the first VoIP server circuitry and the second VoIP server circuitry according to an internet protocol to conference the first mobile device on the first telephone call to the second device on the second telephone call.

2. The method of claim 1, wherein:
the first telephone call is the first communication.

3. The method of claim 1, wherein:
the first communication is a communication according to a text messaging protocol.

4. The method of claim 1, further comprising:
providing the indication of the destination number to an address book service; and
receiving the destination number from the address book service.

5. The method of claim 1, wherein:
the first telephone call is a telephone call initiated by the first VoIP server circuitry to the first mobile device.

6. The method of claim 1, further comprising:
registering the first mobile telephone number with a subscription service; and
consulting the subscription service to determine whether the first mobile telephone number has been registered with the subscription service.

7. The method of claim 1, wherein:
a call from the first mobile device directly to the second device would be charged against credits associated with an account feature of the first mobile device.

8. The method of claim 1, wherein:
the second device is a second mobile phone device;
the second network is a second mobile network; and
the second VoIP server is emulating a mobile phone.

9. The method of claim 1, wherein:
the second device is a landline phone device; and
the second network is a plain old telephone system (POTS) network; and
the second VoIP server is emulating a landline phone.

10. A system to accomplish a call from a first mobile network to a second network by bridging the first mobile network to the second network, the method comprising:
first Voice over Internet Protocol (VoIP) server circuitry configured to emulate a mobile phone, including being configured to receive an initiation of a first communication from a first mobile device to a telephone number associated with the first Voice over Internet Protocol (VoIP) server circuitry; wherein the first VoIP server circuitry is further configured to
receive, from the first mobile device after receiving the initiation of the first communication from the first mobile device, an indication of a destination number of a phone on the second network;
conducting a first telephone call, on the first mobile network, between the first mobile device and the first Voice over Internet Protocol (VoIP) server circuitry;
second VoIP server circuitry, configured to conduct a second telephone call, on the second network, between the second VoIP server circuitry and the destination number of the phone on the second network;
where the first VoIP server circuitry and the second VoIP server circuitry are configured to communicate according to an internet protocol to conference the first mobile device on the first telephone call to the second device on the second telephone call.

11. The system of claim 10, wherein:
the first telephone call is the first communication.

12. The system of claim 10, wherein:
the first communication is a communication according to a text messaging protocol.

13. The system of claim 10, wherein the first VoIP server is further configured to:
provide the indication of the destination number to an address book service; and
receive the destination number from the address book service.

14. The system of claim 10, wherein:
the first telephone call is a telephone call initiated by the first VoIP server circuitry to the first mobile device.

15. The system of claim 10, further comprising:
a subscription service configured to register the first mobile telephone number;
and to provide an indication of whether the first mobile telephone number has been registered with the subscription service.

16. The system of claim 10 wherein:
a call from the first mobile device directly to the second device would be charged against credits associated with an account feature of the first mobile device.

17. The system of claim 10, wherein:
the second device is a second mobile phone device;
the second network is a second mobile network; and
the second VoIP server is configured to emulate a mobile phone.

18. The system of claim 10, wherein:
the second device is a landline phone device; and
the second network is a plain old telephone system (POTS) network; and
the second VoIP server is configured to emulate a landline phone.

19. A VoIP service associated with a first mobile network configured to accomplish a call from the first mobile network to a second network by bridging the first mobile network to the second network, wherein the VoIP service is configured to:
emulate a mobile phone, including being configured to receive an initiation of a first communication from a first mobile device to a telephone number associated with the VoIP service;
receive, from the first mobile device after receiving the initiation of the first communication from the first mobile device, an indication of a destination number of a phone on the second network;
conduct a first telephone call, on the first mobile network, between the first mobile device and the VoIP service; and
communicate with a VoIP service associated with the second network, according to an internet protocol to conference the first mobile device on the first telephone call to a second device on a second telephone call between the VoIP service associated with the second network and the destination number of the phone on the second network.

20. A computer program product for a VoIP service associated with a first mobile network to accomplish a call from the first mobile network to a second network by bridging the first mobile network to the second network, the computer program product comprising at least one computer-readable medium having computer program instructions stored therein which are operable to cause at least one computing device of the VoIP service to:
emulate a mobile phone, including being configured to receive an initiation of a first communication from a first mobile device to a telephone number associated with the VoIP service;
receive, from the first mobile device after receiving the initiation of the first communication from the first mobile device, an indication of a destination number of a phone on the second network;
conduct a first telephone call, on the first mobile network, between the first mobile device and the VoIP service; and
communicate with a VoIP service associated with the second network, according to an internet protocol to conference the first mobile device on the first telephone call to a second device on a second telephone call between the VoIP service associated with the second network and the destination number of the phone on the second network.
